(19) United States
(12) Patent Application Publication
(10) Pub. No.: US 2007/0090640 A1
(43) Pub. Date: Apr. 26, 2007

(54) Project kit

(76) Inventor: Kenneth C. Riead, Blue Springs, MO (US)

Correspondence Address: SPENCER, FANE, BRITT & BROWNE, 1000 WALNUT STREET, SUITE 1400, KANSAS CITY, MO, 64106-2140, US

(21) Appl. No.: 11/259,584

(22) Filed: Oct. 26, 2005

(51) Int. Cl. B42D 15/00

(52) U.S. Cl. 283/117

(57) ABSTRACT

The present invention encompasses a project kit comprising a form document containing a number of sections wherein information relevant to the project is to be recorded, the form document further including identifying indicia associated with each section and located near the side of the document with the identifying indicia for each section located at a unique position along the side of the document, and an instruction document containing text explaining how to complete the form sections, the text arranged so that text pertinent to each section of the form document is grouped together, the instruction document further including identifying indicia associated with each text grouping and located near the side of the documents with the identifying indicia for each text grouping located at a position along the side of the document that is generally aligned with the identifying indicia for the form section to which the text group corresponds. Project specific instruments are also included in the project kit.

### CROSS REFERENCE TO RELATED APPLICATIONS

None.

### STATEMENT REGARDING FEDERALLY SPONSORED RESEARCH AND DEVELOPMENT

None.

### BACKGROUND OF THE INVENTION

The present invention relates generally to a project kit. More specifically, the present invention relates to a project kit having instruction documents and form documents that each contain coordinating identifying indicia.

The “do it yourself” or “do your own” phenomenon continues to grow. Whether driven by necessity, convenience, or a desire to save money, the concept of self-reliance has expanded and continues to expand into many areas of our lives. Each day it seems an ever increasing number of products allow consumers to complete their own projects and solve their own problems.

Many “do your own” products take the form of a project kit. One item most project kits have in common is instructions. After all, one purpose of these kits is to tell a person the best way to get something done, that is, to provide a person with clear, concise instructions that are often developed by a skilled practitioner. Many project kits also include forms for a person to fill out based on the instructions. Thereafter, the person or a professional may then evaluate or analyze the content of the forms to arrive at a conclusion or to find a solution to the problem being addressed.

Unfortunately, currently available instructions and forms leave much to be desired. Generally, these instructions and forms are difficult to use because there is a lack of coordination between the instructions and the forms. Often it is unclear which instructions should be used to complete specific sections of the forms. Accordingly, it is desirable to provide a project kit having instruction documents and form documents that each include coordinating indicia, such as tabs or flags, so that the instructions and forms are simplified, easier to understand, and more efficient to use.

### BRIEF SUMMARY OF THE INVENTION

There is, therefore, provided in the practice of the invention a project kit comprising at least one project specific instrument, a form document containing a plurality of sections wherein information relevant to the project is to be recorded, the form document further including identifying indicia associated with each section and located near the side of the document with the identifying indicia for each section located at a unique position along the side of the document, and an instruction document containing text explaining how to complete the sections of the form document, the text arranged so that the text pertinent to each section is grouped together, the instruction document further including identifying indicia associated with each text grouping and located near the side of the document with the identifying indicia for each text grouping located at a position along the side of the document that is generally aligned with the identifying indicia for the section of the form document to which the text group corresponds.

In one embodiment of the invention, the identifying indicia is printed on the form document and/or the instruction document.

In another embodiment of the invention, the identifying indicia extends from the side of the form document and/or the instruction document.

In yet another embodiment of the invention, the identifying indicia associated with a section of the form document and the identifying indicia associated with the text grouping pertinent to that section are the same color.

In another embodiment of the invention, the identifying indicia associated with a section of the form document and the identifying indicia associated with the text grouping pertinent to that section are the same shape.

In accordance with yet another embodiment of the present invention, the project kit further includes a storage container for carrying the project-specific instruments.

In yet another embodiment of the invention, the project specific instruments include a measuring device, a screwdriver, and a calculator.

It is to be understood that the invention is not limited in its application to the details of construction and to the arrangements of the components set forth in the following description or illustrated in the drawings. The invention is capable of embodiments in addition to those described and of being practiced and carried out in various ways. As such, those skilled in the art will appreciate that the conception upon which this disclosure is based may readily be utilized as a basis for the designing of other structures, methods and systems for carrying out the several purposes of the present invention. Also, it is to be understood that the phraseology and terminology employed herein are for the purpose of description and should not be regarded as limiting.

### BRIEF DESCRIPTION OF THE DRAWINGS

Further features of the present invention will become apparent to those skilled in the art to which the present invention relates from reading the following description with reference to the accompanying drawings, in which:

FIG. 1 is a perspective view of an open storage container for a project kit according to one embodiment of the present invention and including a set of instruction and form documents positioned therein;

FIG. 2 is a perspective view a project kit according to one embodiment of the present invention that includes the storage container and documents of FIG. 1 and that further includes project specific instruments;

FIG. 3 is a perspective view of the storage container of FIG. 2 in a closed position;

FIG. 4 is a perspective view of a storage container according to another embodiment of the present invention and with project specific instruments included therein;

FIG. 5 is a front view of a storage container according to yet another embodiment of the present invention;

FIG. 6 is a front view of one page of a form document containing four sections, Steps 1A, 2A, 3A, and 4A, and one page of an instruction document containing text for section Step 1A according to one embodiment of the present invention;

FIG. 7 is a front view of the form document page from FIG. 6 and one page of an instruction document containing text for section Step 2A;

FIG. 8 is a front view of one page of a form document containing two sections, Steps 1B and 2B, and one page of an instruction document containing text for section Step 1B according to one embodiment of the present invention;

FIG. 9 is a front view of the form document page from FIG. 8 and one page of an instruction document containing text for section Step 2B;

FIG. 10 is a front view of one page of a form document containing two sections, Steps 1C and 2C, and one page of an instruction document containing text for section Step 1C according to one embodiment of the present invention;

FIG. 11 is a front view of the form document page from FIG. 10 and one page of an instruction document containing text for section Step 2C;

FIG. 12 is a front view of one page of a form document containing three sections, Step 1D, 2D, and 3D, and one page of an instruction document containing text for section Step 2D according to one embodiment of the present invention; and

FIG. 13 is a front view of the form document page from FIG. 12 and one page of an instruction document containing text for section Step 3D.

### DETAILED DESCRIPTION OF THE INVENTION

The present invention includes a project kit having instructions and forms that each contain coordinating indicia so that the instructions and forms are simpler and more efficient to use. The invention will now be described with reference to the drawing figures, in which like reference numerals refer to like parts throughout. It should be understood that proportional relationships of the elements have not necessarily been maintained in the figures so that the characteristics of the present invention are clear.

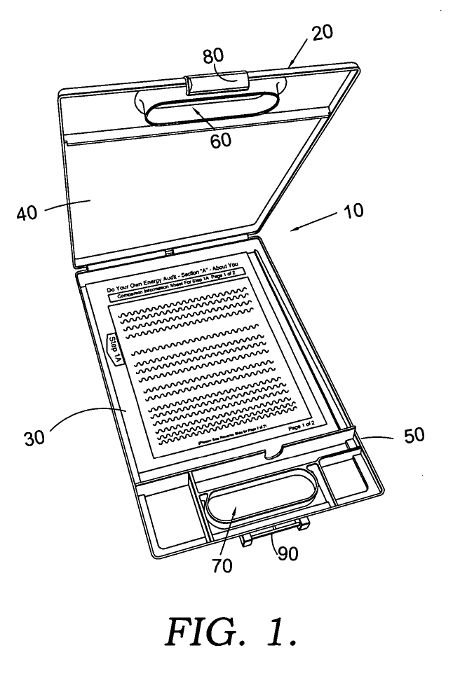

Turning now to the figures, FIG. 1 shows one embodiment of a project kit 10 that includes a storage container 20 having positioned therein a set of instruction documents and form documents 30. In this embodiment, the storage container includes a top section 40 hingably connected to a bottom section 50. The top section 40 defines an opening 60 and the bottom section 50 defines a corresponding opening 70 so that when the storage container is closed a person may carry the storage container 20 by inserting their hand through the openings 60, 70 and lifting the storage container 20. Additionally, top section 40 includes a locking clasp 80 that cooperates with a flange 90 extending from bottom section 50 to lock the storage compartment 20 when it is closed.

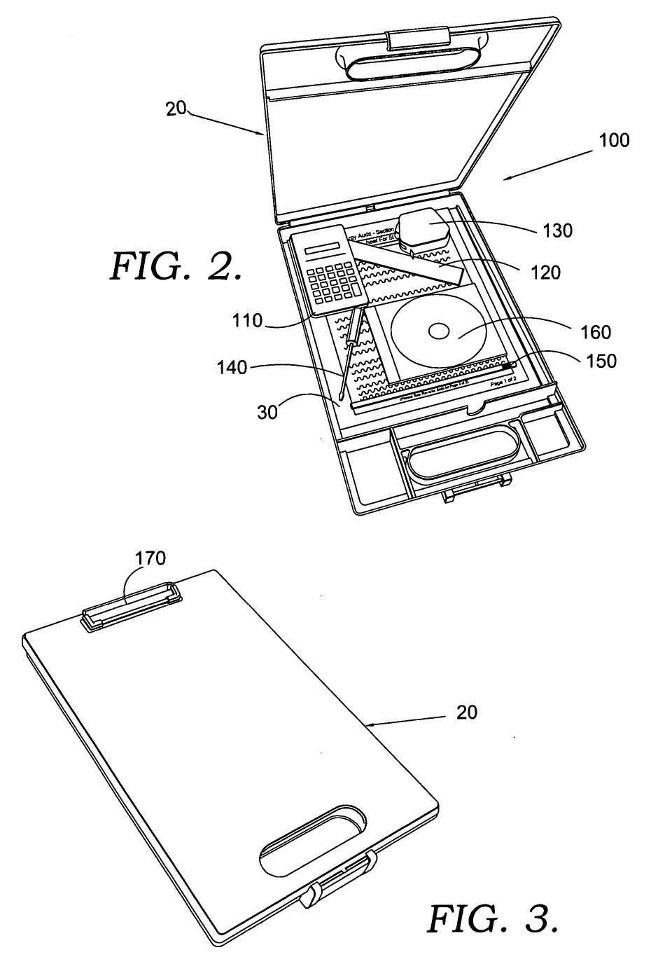

Referring now to FIG. 2, in one embodiment, a project kit 100 according to one embodiment of the present invention includes a storage container 20 having positioned therein a set of instruction documents and form documents 30 and project specific instruments. In this embodiment, the project kit is intended for a residential energy audit. Thus, the project specific instruments include a calculator 110 for calculating areas and the like, two measuring devices (a ruler 120 and a tape measure 130) for determining home and/or room dimensions or for measuring gaps and/or insulation depth, a screw driver 140, and a pencil 150 for use in recording information. It will be understood that different instruments will be included in other embodiments of the project kit.

Continuing with FIG. 2, this particular project kit also includes a compact disc 160 that contains information pertinent to an energy audit. Such information may include, for example, background information, suggested ways to improve energy efficiency, software programs for analyzing information recorded on the forms, and links to additional information. It should be understood that the compact disc 160 is only one example of a computer readable media that may be included in the project kit 100. Additional computer readable media will also suffice.

In FIG. 1 and FIG. 2, the storage compartment 20 is shown in an open position. In FIG. 3, the storage compartment 20 is closed and locked. Additionally, in this embodiment, storage compartment 20 is essentially a clip board that includes a clasp 170 operable to retain documents against the container.

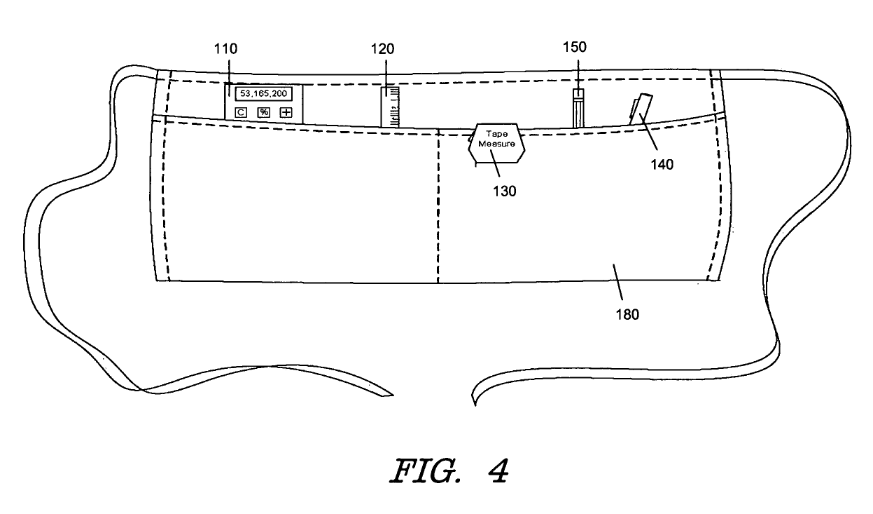

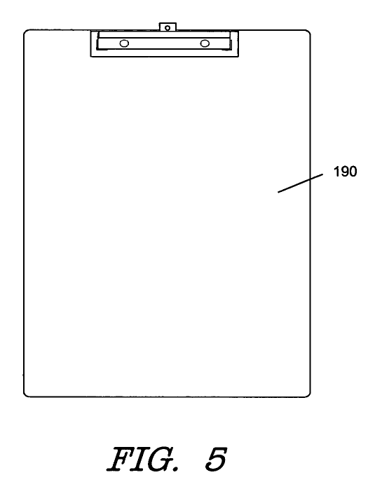

Referring now to FIG. 4, in yet another embodiment of the present invention, the project kit may include a storage container that is a carpenter's apron 180. A number of project specific instruments are included in the carpenter's apron 180. In particular, the carpenter's apron 180 includes a calculator 110, two measuring devices (a ruler 120 and a tape measure 130), a screw driver 140, and a pencil 150.

It should be understood that the storage compartment may take many shapes and be formed from any suitable material, including plastics, metals such as aluminum, or even textiles such as broadcloth, and manufactured by any suitable method. Thus, for example, the storage compartment 20 shown in FIG. 1 may be formed from plastic and manufactured by injection molding techniques or the like or it may be formed from aluminum and manufactured using a stamping mechanism or the like. As another example, the storage compartment shown in FIG. 4, that is the carpenter's apron 180, may be formed from broadcloth and manufactured in a sewing application. FIG. 5 shows a clipboard 190 made largely from hardboard. This clipboard 190 is yet another example of a storage compartment that may be utilized in the present invention. Other examples of storage containers include a zippered notebook and a toolbox.

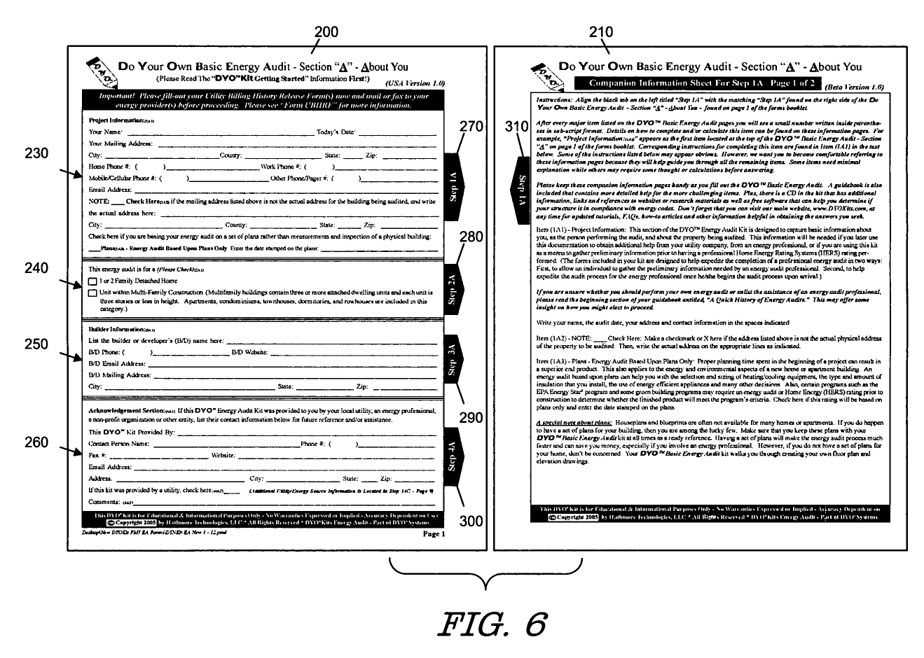

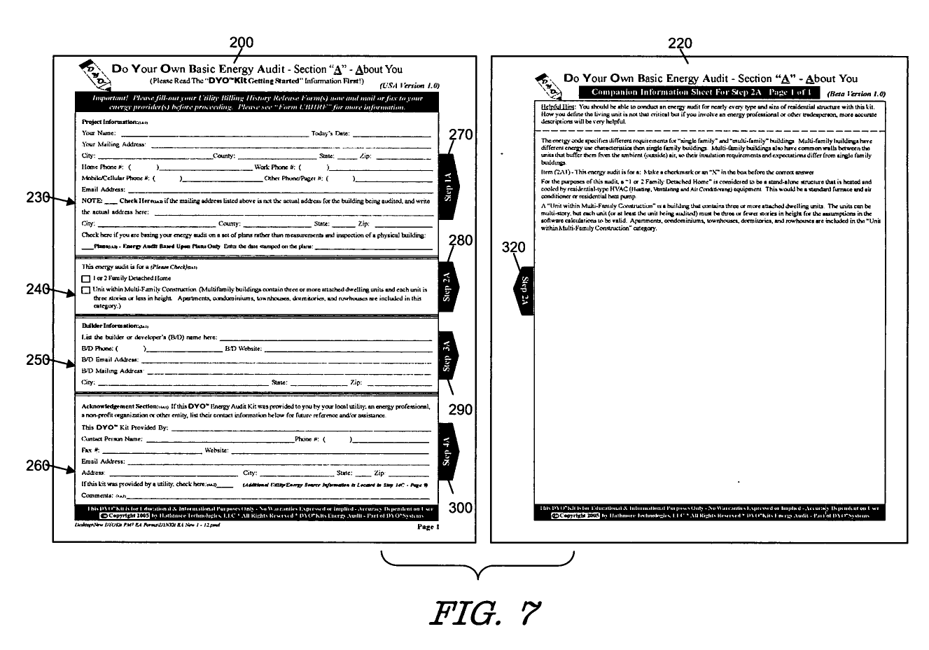

Turning now to FIGS. 6 and 7, these figures show one page from a form document 200 and two pages from an instruction document 210, 220. As can be seen in the figures, page 200 is separated into four sections 230, 240, 250, and 260. Associated with each section is an identifying indicia located near the right side of the page 200. In particular, tab 270 is labeled “Step 1A” and is associated with the first section 230, tab 280 is labeled “Step 2A” and is associated with the second section 240, tab 290 is labeled “Step 3A” and is associated with the third section 250, and tab 300 is labeled “Step 4A” and is associated with the fourth section 260.

As can further be seen in the figures, the pages from the instruction document 210, 220 contain text, and more specifically, contain text associated with a particular form section. Each of these pages 210, 220 also has an identifying indicia located near the left side of the page. In particular, page 210 has a tab 310 labeled “Step 1A” and page 220 has a tab 320 labeled “Step 2A.” It should be understood that the text contained in page 210 is pertinent to section 230 and the text contained in page 220 is pertinent to section 240.

As may also be seen in the documents, the identifying indicia associated with a form section and the identifying indicia associated with the text grouping pertinent to that form section are located at a unique position along the side of the document. Thus, when page 210 is placed side-by-side with page 200 as in FIG. 6, tab 270 and tab 310 are aligned. Likewise, when page 220 is placed side-by-side with page 200 as in FIG. 7, tab 280 and tab 320 are aligned. By locating the identifying indicia in this manner a person will easily and readily be able to identify the specific instruction page pertinent to each particular form section.

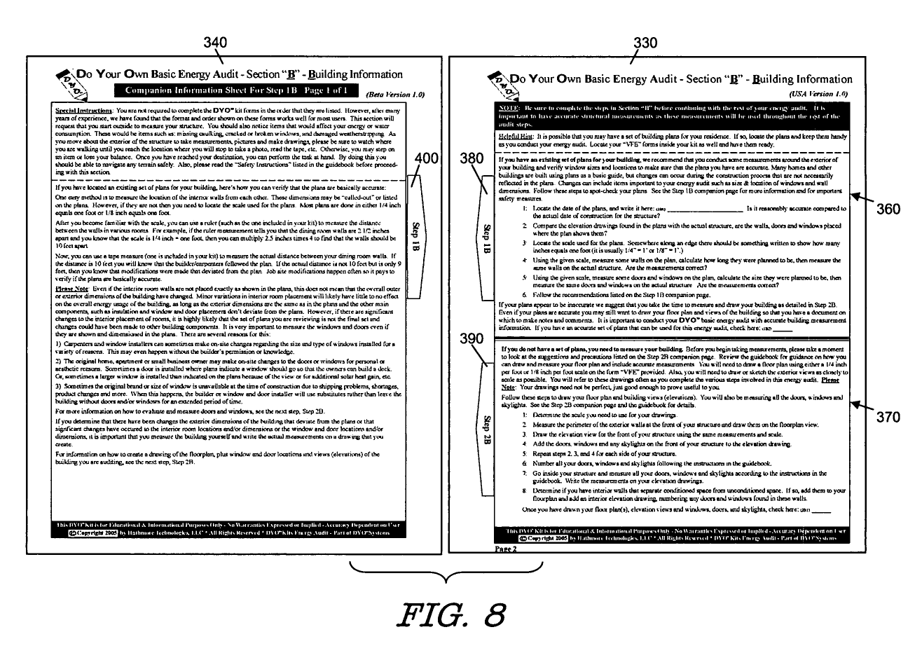

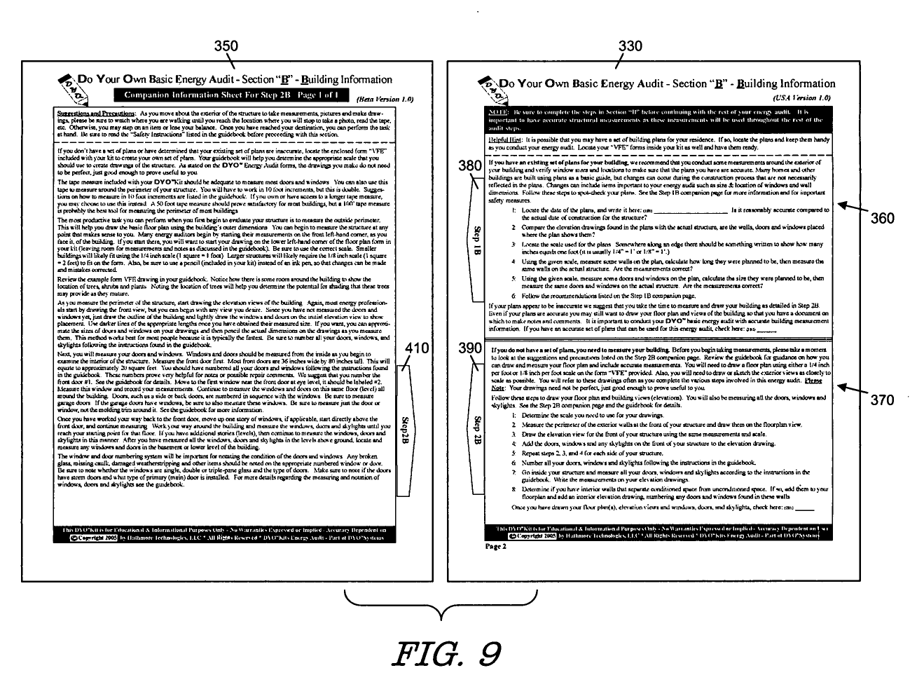

Turning now to FIGS. 8 and 9, these figures show one page from a form document 330 and two pages from an instruction document 340, 350. Page 330 is separated into two sections 360, 370. Associated with each section is an identifying indicia located near the left side of the page 330. In particular, tab 380 is labeled “Step 1B” and is associated with the first section 360 and tab 390 is labeled “Step 2B” and is associated with the second section 370. Regarding the pages from the instruction document 340, 350, each of these pages also has an identifying indicia located near the right side of the page. In particular, page 340 has a tab 400 labeled “Step 1B” and page 350 has a tab 410 labeled “Step 2B.” It should be understood that the text contained in page 340 is pertinent to section 360 as is indicated by the alignment of tab 400 and tab 380 and the text contained in page 350 is pertinent to section 370 as is indicated by the alignment of tab 410 and tab 390.

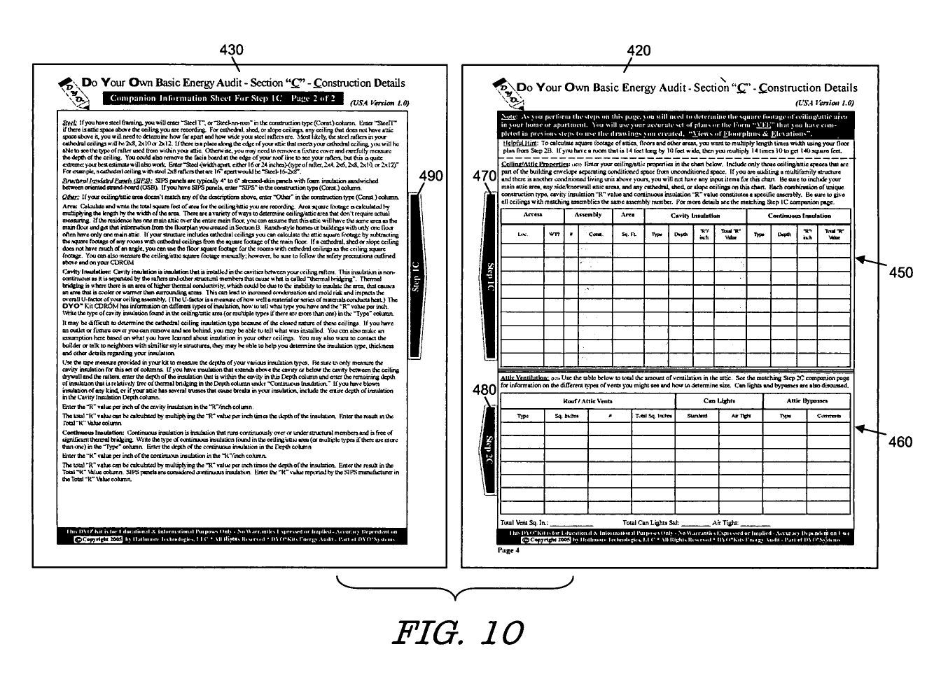

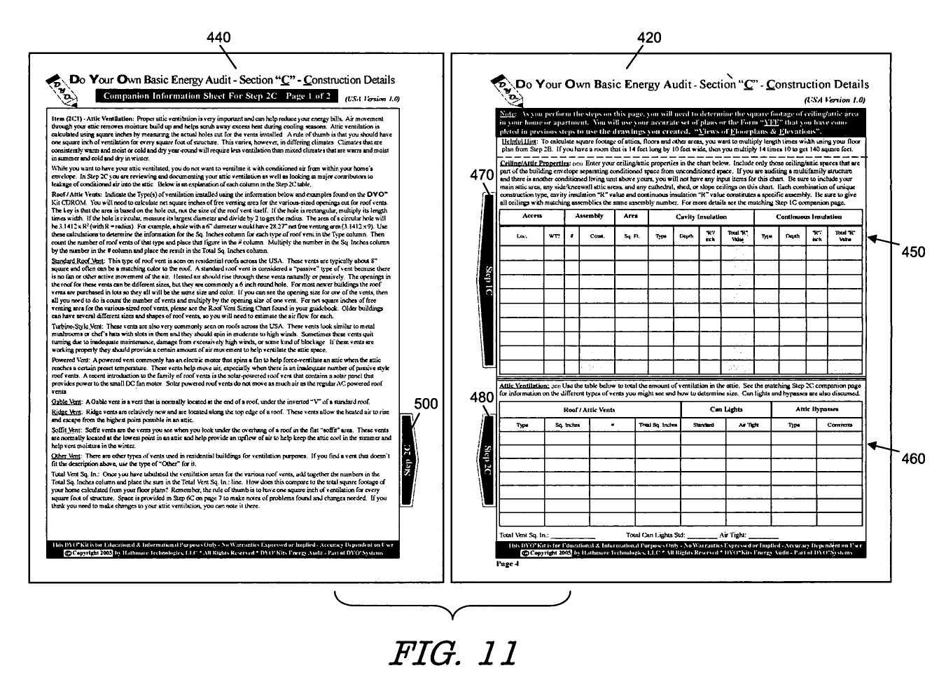

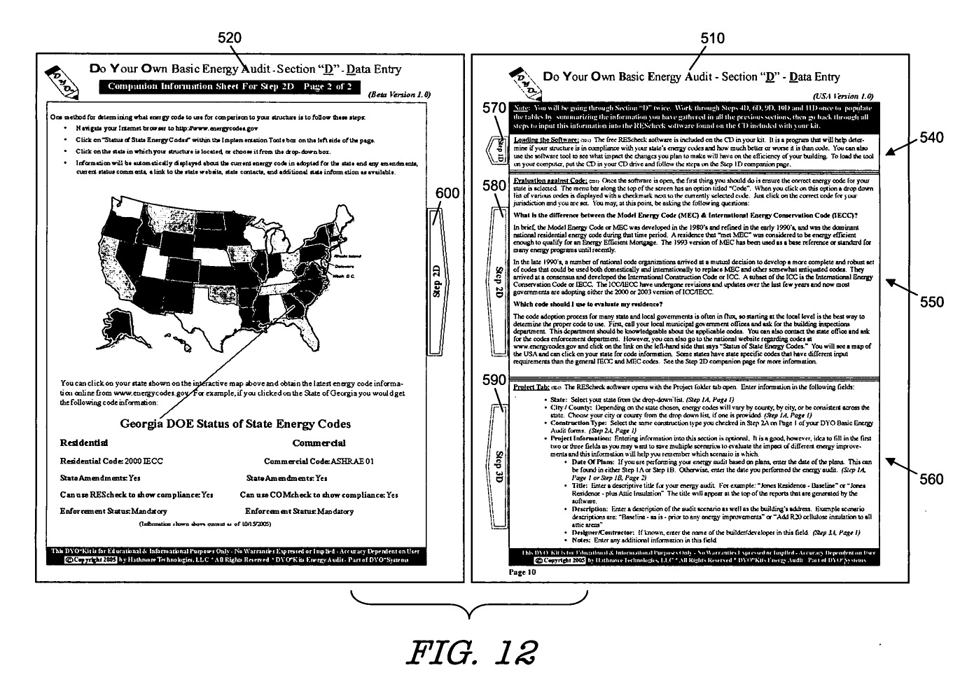

FIGS. 10 and 11 show one page from a form document 420 and two pages from an instruction document 430, 440. Page 420 is separated into two sections 450, 460. Associated with each section is an identifying indicia located near the left side of the page 420. In particular, tab 470 is labeled “Step 1C” and is associated with the first section 450 and tab 480 is labeled “Step 2C” and is associated with the second section 460. Regarding the pages from the instruction document 430,440, each of these pages also has an identifying indicia located near the right side of the page. In particular, page 430 has a tab 490 labeled “Step 1C” and page 440 has a tab 500 labeled “Step 2C.” It should be understood that the text contained in page 430 is pertinent to section 450 as is indicated by the alignment of tab 490 and tab 470 and the text contained in page 440 is pertinent to section 460 as is indicated by the alignment of tab 500 and tab 480.

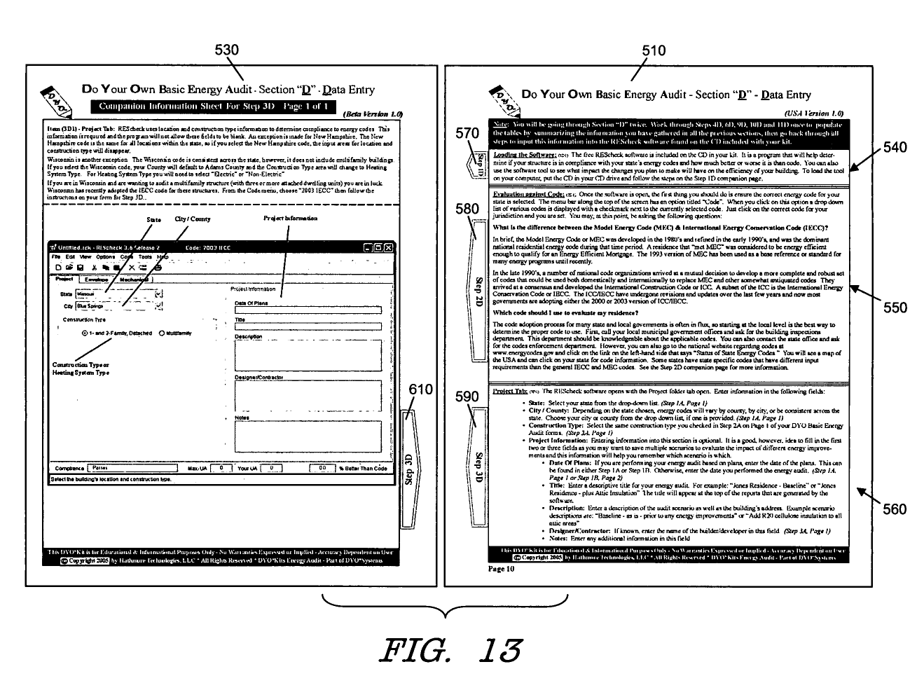

FIGS. 12 and 13 show one page from a form document 510 and two pages from an instruction document 520, 530. Page 510 includes three sections 540, 550, 560. Associated with each section is an identifying indicia located near the left side of the page 510. In particular, tab 570 is labeled “Step 1D” and is associated with the first section 540, tab 580 is labeled “Step 2D” and is associated with the second section 550, and tab 590 is labeled “Step 3D” and is associated with the third section 560. Regarding the page from the instruction document 520, 530, each of these pages has identifying indicia located near the right side of the page. In particular, page 520 has a tab 600 labeled “Step 2D” and page 530 has a tab 610 labeled “Step 3D.” It should be understood that the text in page 520 is pertinent to section 550 in page 510 as is indicated by the alignment of tab 600 and tab 580 and the text in page 530 is pertinent to section 560 in page 510 as is indicated by the alignment of tab 610 and tab 590.

In the embodiments shown in figures, the identifying indicia are printed directly on the individual pages and within the page boundaries. It should be understood, however, that the identifying indicia may be printed on other items, such as a label, and then affixed to the documents in appropriate locations. Moreover, it should be understood that the identifying indicia may be printed on tabs that extend from the side of the documents at the appropriate locations.

Additionally, it should be understood that the identifying indicia may be different colors. For example, in the embodiment shown in FIGS. 6 and 7, the identifying indicia have a black background and white text, but in the embodiment shown in FIGS. 8 and 9, the identifying indicia have a white background within a black boundary and have black text. Thus, it should be understood that the identifying indicia may be printed in a color different from the text and that corresponding identifying indicia may be printed in the same color while other indicia pairs are printed in different colors so that the corresponding identifying indicia are even more readily identified.

It should also be understood that the identifying indicia may include different printed graphics. For example, in the embodiments shown in FIGS. 6, 7, 8, and 9, the identifying indicia are the same shape, that is a generally triangular shape, having a single background color. However, in the embodiments shown in FIGS. 10, 11, 12, and 13, while these indicia have the same general shape, they also have a double border line.

It should further be understood that the identifying indicia may be different shapes and that each pair of corresponding identifying indicia may have different shapes so that the corresponding identifying indicia are even more readily identified.

As stated above, in the figures, the identifying indicia are printed at or near the side of the pages. It should be understood that the particular side for the indicia may be reversed or, in the case of form documents or instruction documents bundled into a booklet or pamphlet, that the particular sides may not be consistent for all of the documents. In a situation where they are bundled into a packet or pamphlet, the form documents and instruction documents will have the identifying indicia on the right or left side depending on which edge of the document faces out from the center of the booklet or pamphlet.

Having described the invention, it should be apparent that the invention is both inexpensive and easy to implement and use especially when compared to current project kits. Although the above invention is described in part using a residential audit kit, as stated above, it will be appreciated that the invention is equally applicable to other projects. Additionally, from the above description of the invention, those skilled in the art will perceive improvements, changes and modifications. Such improvements, changes and modifications within the skill of the art are intended to be covered by the appended claims.

Having described at least one preferred embodiment of the invention, what is claimed is:

1. A project kit comprising:
at least one project specific instrument;
a form document, the form document containing a plurality of sections wherein information relevant to the project is to be recorded, the form document further including identifying indicia associated with each section and located near the side of the documents with the identifying indicia for each section located at a unique position along the side of the document; and
an instruction document, the instruction document containing text explaining how to complete the sections of the form document, the text arranged so that text pertinent to each section of the form document is grouped together, the instruction document further including identifying indicia associated with each text grouping and located near the side of the documents with the identifying indicia for each text grouping located at a position along the side of the document that is generally aligned with the identifying indicia for the form section to which the text group corresponds.

2. The project kit according to claim 1 wherein the identifying indicia is printed on the instruction documents.

3. The project kit according to claim 1 wherein the identifying indicia is printed on the form document.

4. The project kit according to claim 1 wherein the identifying indicia extends from the side of the instruction documents.

5. The project kit according to claim 1 wherein the identifying indicia extends from the side of the form document.

6. The project kit according to claim 1 wherein the identifying indicia associated with a form section and the identifying indicia associated with the text grouping pertinent to the form section are the same color.

7. The project kit according to claim 6 wherein the color of the identifying indicia associated with a form section and the identifying indicia associated with the text grouping pertinent to the form section is different from the color of other identifying indicia.

8. The project kit according to claim 1 wherein the identifying indicia associated with a form section and the identifying indicia associated with the text grouping pertinent to the form section are the same shape.

9. The project kit according to claim 8 wherein the identifying indicia have a generally triangular shape.

10. The project kit according to claim 8 wherein the shape of the identifying indicia associated with a form section and the identifying indicia associated with the text grouping pertinent to the form section is different from the shape of other identifying indicia.

11. The project kit according to claim 1 further including a storage container for carrying the project specific instruments.

12. The project kit according to claim 11 wherein the storage container includes a clasp operable to retain documents against the container.

13. The project kit according to claim 11 wherein the storage container is made substantially from plastic.

14. The project kit according to claim 1 wherein the project specific instruments include a screw driver.

15. The project kit according to claim 1 wherein the project specific instruments include a measuring device.

16. The project kit according to claim 15 wherein the measuring device is a tape measure.

17. The project kit according to claim 1 wherein the project specific instruments include a calculator.

18. The project kit according to claim 1 further including a computer readable media containing information relevant to the project.
